(19) United States
(12) Patent Application Publication
(10) Pub. No.: US 2024/0375721 A1
(43) Pub. Date: Nov. 14, 2024

(54) LOWER VEHICLE BODY STRUCTURE

(71) Applicant: HONDA MOTOR CO., LTD., Tokyo (JP)

(72) Inventors: Masayasu Yoshida, Wako-shi (JP); Satoru Kawabe, Wako-shi (JP); Hiroyo Miyanaga, Wako-shi (JP); Hisashi Suzuki, Wako-shi (JP)

(21) Appl. No.: 18/659,046

(22) Filed: May 9, 2024

(30) Foreign Application Priority Data
May 11, 2023 (JP) 2023-078848

(51) Int. Cl. B62D 25/20; B62D 21/03; B62D 27/00

(52) U.S. Cl. CPC B62D 25/20; B62D 21/03; B62D 27/00

(57) ABSTRACT

This lower vehicle body structure includes a pair of side frames extending substantially in a vehicle body front-rear direction at a rear side or a front side of a center in the vehicle body front-rear direction, a cross member connected to the pair of side frames, and a floor panel structure joined to the pair of side frames and the cross member, in which the cross member includes a pair of inclined extension portions bent at an obtuse angle and extending from both end parts of a central region in a vehicle width direction toward a center side in the vehicle body front-rear direction, the floor panel structure includes a reinforcing bead extending from a position on an outer side of the cross member in the vehicle body front-rear direction toward the center side in the vehicle body front-rear direction to be in contact with the cross member, and the reinforcing bead extends to a position that does not reach a joint portion of the cross member with the floor panel structure on the center side in the vehicle body front-rear direction.

### CROSS-REFERENCE TO RELATED APPLICATION

The present application claims priority based on Japanese Patent Application No. 2023-078848, filed May 11, 2023, the content of which is incorporated herein by reference.

### BACKGROUND OF THE INVENTION

### Field of the Invention

The present invention relates to a lower vehicle body structure of a vehicle.

### Description of Related Art

As a lower vehicle body structure of four-wheeled vehicles, there is one in which a cross member is connected to a pair of rear side frames extending substantially in a vehicle body front-rear direction, and a floor panel is joined to the pair of rear side frames and the cross member. In this type of lower vehicle body structure, when an impact load is input to the floor panel from the rear of the vehicle, it is desired that the load can be transmitted smoothly from the floor panel to the cross member, and that energy of the impact load can be efficiently absorbed by the floor panel crushing backward and forward. Conventionally, various technologies have been devised to realize such a demand (for example, see Japanese Unexamined Patent Application, First Publication No. 2000-16348).

In the lower vehicle body structure described in Japanese Unexamined Patent Application, First Publication No. 2000-16348, a reinforcing bead extending substantially in a vehicle body front-rear direction is formed on a floor panel joined to a pair of rear side frames and a cross member. In a case of this lower vehicle body structure, when an impact load is input to the rear of the floor panel from the rear of the vehicle, the reinforcing bead smoothly transmits the input load to the cross member. Also, at this time, energy of the impact load is efficiently absorbed by crushing of the floor panel that is reinforced by the reinforcing bead.

Also, as a lower vehicle body structure of four-wheeled vehicles, a cross member connected to left and right rear side frames being configured to be a cross member having a non-linear portion (bent portion) for the connection has been devised (for example, see Japanese Unexamined Patent Application, First Publication No. 2016-078658).

In the lower vehicle body structure described in Japanese Unexamined Patent Application, First Publication No. 2016-078658, a pair of inclined extension portions extending at an obtuse angle from both end parts of a central region of the cross member in a vehicle width direction toward a vehicle front side are provided, and outer end parts of the inclined extension portions are connected to the left and right rear side frames. A floor panel is joined to the left and right rear side frames and the cross member.

Also in this type of lower vehicle body structure, it is desirable that a reinforcing bead extending substantially in a vehicle body front-rear direction be provided on a floor panel structure (including a case of it being formed of a plurality of panels) to smoothly transmit an impact load and improve absorption performance of energy of the impact load.

### SUMMARY OF THE INVENTION

However, in the lower vehicle body structure in which the cross member having the inclined extension portions is employed, if the reinforcing bead extending substantially in a vehicle body front-rear direction is applied to the floor panel structure, when an impact load in the vehicle body front-rear direction is input to the cross member from the reinforcing bead, the inclined extension portions of the cross member are likely to be deformed to open outward. Then, when the inclined extension portions of the cross member are deformed to open outward, left and right side frames are pushed to extend outward in a vehicle width direction, and the input load cannot be efficiently received. If the left and right side frames cannot efficiently receive the impact load, energy absorption due to crushing of the floor panel structure or the like is difficult to proceed smoothly.

An aspect of the present invention is to provide a lower vehicle body structure in which an impact load in a vehicle body front-rear direction input to a floor panel structure can be efficiently received by side frames, and energy absorption due to crushing of the floor panel structure or the like can proceed smoothly. Then, the aspect of the present invention eventually contributes to development of a sustainable transportation system.

In order to achieve the above-described objective, a lower vehicle body structure according to an aspect of the present invention employs the following configuration.

(1) An aspect of the present invention includes a pair of side frames (for example, the rear side frames 10 of the embodiment) extending substantially in a vehicle body front-rear direction at a rear side or a front side of a center in the vehicle body front-rear direction, a cross member (for example, the rear cross member 13 of the embodiment) connected to the pair of side frames, and a floor panel structure (for example, the floor panel structure 15 of the embodiment) joined to the pair of side frames and the cross member, in which the cross member includes a pair of inclined extension portions (for example, the inclined extension portions 13s of the embodiment) bent at an obtuse angle and extending from both end parts of a central region (for example, the central extension portion 13c of the embodiment) in a vehicle width direction toward a center side in the vehicle body front-rear direction, the floor panel structure includes a reinforcing bead (for example, the reinforcing bead 23 of the embodiment) extending from a position on an outer side of the cross member in the vehicle body front-rear direction toward the center side in the vehicle body front-rear direction to be in contact with the cross member, and the reinforcing bead extends to a position that does not reach a joint portion (for example, the front joint portion 35 of the embodiment) of the cross member with the floor panel structure on the center side in the vehicle body front-rear direction.

According to the aspect (1) described above, when an impact load is input from the vehicle body front-rear direction through the floor panel structure, the impact load is transmitted to the cross member along the reinforcing bead. At this time, although the reinforcing bead transmits the load to the cross member, it does not reach the joint portion of the cross member with the floor panel structure on the center side in the vehicle body front-rear direction. Therefore, tension of the floor panel structure acts on the joint portion of the cross member with the floor panel structure on the center side in the vehicle body front-rear direction to suppress deformation of the inclined extension portions of the cross member.

That is, if the reinforcing bead extends to straddle the joint portion of the cross member with the floor panel structure on the center side in the vehicle body front-rear direction, when a groove shape of the reinforcing bead deforms to be pushed open when an impact load is input, the tension of the floor panel structure acting on the joint portion of the cross member with the floor panel structure on the center side in the vehicle body front-rear direction to suppress deformation of the inclined extension portions is no longer applied. In contrast, in the configuration described above, since the reinforcing bead does not reach the joint portion of the cross member with the floor panel structure on the center side in the vehicle body front-rear direction, the tension of the floor panel structure acts on the joint portion of the cross member with the floor panel structure on the center side in the vehicle body front-rear direction to suppress the deformation of the inclined extension portions of the cross member.

Therefore, if an impact load is input from the vehicle body front-rear direction through the floor panel structure, the cross member receives the load from the reinforcing bead, and deformation due to an inclination angle of the inclined extension portions of the cross member trying to extend thereby is less likely to occur. Therefore, when the present configuration is employed, a bent portion of the cross member deforming in an opening direction can be suppressed, and the impact load input to the floor panel structure can be efficiently received by the side frames.

(2) In the aspect (1) described above, an installation portion (for example, the support bracket 19r of the embodiment) of a part (for example, the drive unit 18 of the embodiment) disposed below a vehicle body may be fixed to the central region of the cross member, and the reinforcing bead may be disposed at a position intersecting the installation portion in the vehicle width direction.

In this case, an impact load in the vehicle body front-rear direction input to the reinforcing bead is input to a portion of the central region of the cross member to which the installation portion of the part is fixed. A portion of the central region of the cross member to which the impact load is input through the reinforcing bead is reinforced by the installation portion of the part. Therefore, the central region of the cross member becomes difficult to deform, and it also becomes difficult for deformation behavior of the reinforcing bead in an opening shape to be transmitted to the inclined extension portion side of the cross member.

(3) In the aspect (1) described above, an installation portion (for example, the support bracket 19r of the embodiment) of a part (for example, the drive unit 18 of the embodiment) disposed below a vehicle body may be fixed to the central region of the cross member, and the installation portion may be fixed to straddle a bent portion (for example, the bent portion 13b of the embodiment) between the central region and each of the inclined extension portions of the cross member.

In this case, the bent portion between the central region and the inclined extension portion of the cross member is firmly reinforced by the installation portion of the part. Therefore, when an impact load is input to the reinforcing bead from the vehicle body front-rear direction, deformation with the bent portion of the cross member as a starting point can be suppressed by the installation portion of the part. Therefore, when the present configuration is employed, an impact load input to the floor panel structure can be more efficiently received by the side frames.

(4) In the aspect (1) described above, the reinforcing bead may extend to the center side in the vehicle body front-rear direction beyond the joint portion (for example, the rear joint portion 30 of the embodiment) of the cross member with the floor panel structure on an outer side in the vehicle body front-rear direction.

In this case, a load input to the floor panel structure in the vehicle body front-rear direction can be more efficiently transmitted to the cross member through the reinforcing bead.

(5) In the aspect (4) described above, a plurality of the reinforcing beads may be provided on the floor panel structure to be spaced apart from each other in the vehicle width direction, and the reinforcing bead intersecting the inclined extension portion of the cross member may extend further to the center side in the vehicle body front-rear direction than the reinforcing bead intersecting the central region of the cross member.

In this case, when the reinforcing bead intersecting the inclined extension portion of the cross member is made to extend to the maximum extent to the center side in the vehicle body front-rear direction, an impact load input to the floor panel structure can be efficiently transmitted to the cross member via the plurality of reinforcing beads while suppressing deformation of the inclined extension portion of the cross member.

According to the aspects of the present invention, the reinforcing bead of the floor panel structure extends to a position that does not reach the joint portion of the cross member with the floor panel structure on the center side in the vehicle body front-rear direction. Therefore, when an impact load in the vehicle front-rear direction is input, the input load is smoothly transmitted to the cross member via the reinforcing bead, and deformation of the inclined extension portion of the cross member in an opening direction can be suppressed. Therefore, when the aspects of the present invention are employed, the impact load in the vehicle body front-rear direction input to the floor panel structure can be efficiently received by the side frames, and energy absorption due to crushing of the floor panel structure or the like can proceed smoothly. Therefore, when the aspects of the present invention are employed, it is possible to contribute to development of a sustainable transportation system.

### BRIEF DESCRIPTION OF THE DRAWINGS

FIG. 1 is a view of a vehicle of a first embodiment from below.

FIG. 2 is a cross-sectional view of the vehicle of the first embodiment along line II-II in FIG. 1.

FIG. 3 is a cross-sectional view of a vehicle of a second embodiment similar to FIG. 2.

FIG. 4 is a view of the vehicle of the second embodiment from below.

FIG. 5 is a cross-sectional view of a vehicle of a third embodiment similar to FIG. 2.

### DESCRIPTION OF EMBODIMENTS

Hereinafter, embodiments of the present invention will be described on the basis of the drawings. Further, in the following description, terms such as forward and rearward, upward and downward, and leftward and rightward mean directions with respect to a forward direction of a vehicle unless otherwise specified. Further, an arrow FR indicating a forward direction with respect to the vehicle, an arrow UP indicating an upward direction with respect to the vehicle, and an arrow LH indicating a leftward direction with respect to the vehicle are illustrated at suitable positions in the drawings.

Also, in the embodiments described below, portions the same as each other will be denoted by the same reference signs, and some duplicate description will be omitted.

### First Embodiment

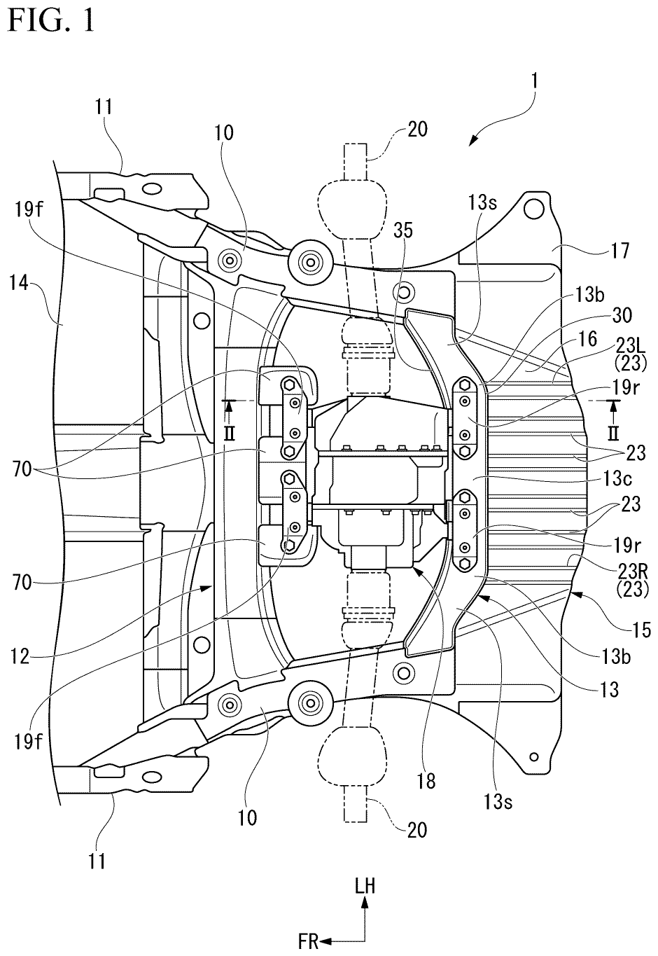

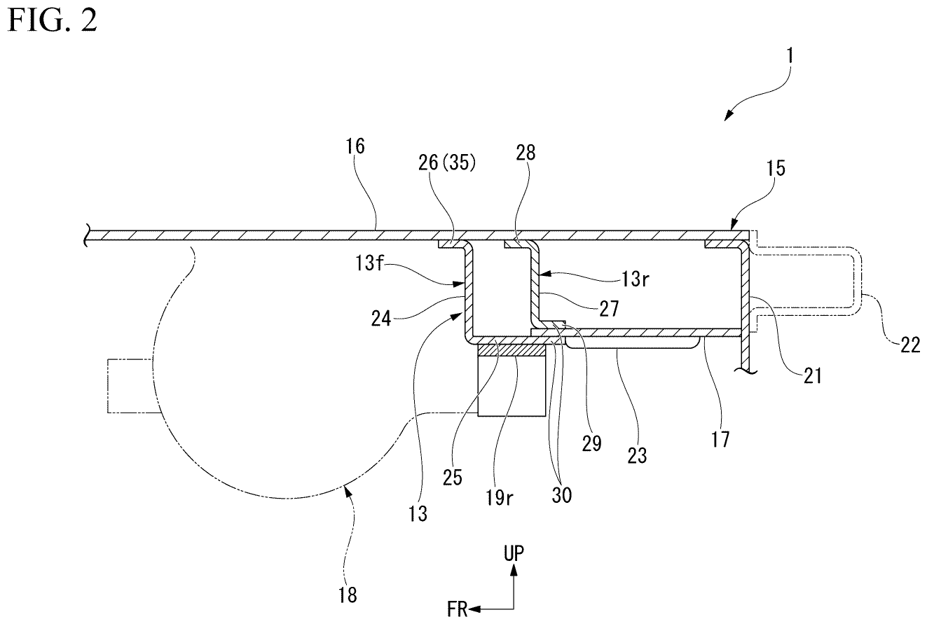

FIG. 1 is a view of a rear region of a vehicle 1 of the present embodiment from below. FIG. 2 is a cross-sectional view along line II-II in FIG. 1.

A pair of rear side frames 10 (side frames) extending substantially in a vehicle front-rear direction are disposed on both left and right sides of the rear region of the vehicle 1. Front end parts of the left and right rear side frames 10 are connected to left and right side sills 11 disposed below and outside a passenger compartment in a vehicle width direction. The left and right side sills 11 extend in a vehicle body front-rear direction. Front regions of the left and right rear side frames 10 are connected to each other by a front cross member 12 extending substantially in the vehicle width direction. Rear regions of the left and right rear side frames 10 are connected to each other by a rear cross member 13 (cross member) extending substantially in the vehicle width direction.

A front floor panel 14 covering a lower portion of the passenger compartment is joined to the left and right side sills 11. A rear floor panel structure 15 covering a lower portion of a luggage compartment behind the passenger compartment is joined to the left and right rear side frames 10, the front cross member 12, and the rear cross member 13. The floor panel structure 15 has a double panel structure including an upper wall panel 16 and a lower wall panel 17 to be described in detail later.

A drive unit 18 for driving the vehicle is supported by the front cross member 12 and the rear cross member 13. A front edge part of the drive unit 18 is supported by a plurality of support blocks 70 joined to a rear edge part of the front cross member 12, and a rear edge part of the drive unit 18 is supported by the rear cross member 13. The plurality of support blocks 70 are welded and fixed to the rear edge part of the front cross member 12 and a lower surface of a front edge part of the upper wall panel 16 of the floor panel structure 15. The drive unit 18 is fastened and fixed to lower surfaces of the plurality of support blocks 70 and the rear cross member 13 via a vibration isolation mount and support brackets 19f and 19r (not illustrated).

In the present embodiment, the drive unit 18 constitutes a part disposed below the vehicle body, and two support brackets 19r fastened and fixed to the lower surface of the rear cross member 13 constitute an installation portion of the part disposed below the vehicle body.

A pair of drive shafts 20 are provided to extend outward in the left-right direction of the vehicle body from the drive unit 18. Distal end sides of the left and right drive shafts 20 are supported by the vehicle body via a rear suspension device (not illustrated). A rear wheel (not illustrated) is attached to a distal end part of each of the drive shafts 20.

As illustrated in FIG. 2, the floor panel structure 15 includes the upper wall panel 16 extending between a rear end part of the front floor panel 14 (see FIG. 1) and a rear end part of the vehicle body, the lower wall panel 17 extending between a rear end part of the rear cross member 13 and the rear end part of the vehicle body below the upper wall panel 16, and a rear panel 21 connecting rear end parts of the upper wall panel 16 and the lower wall panel 17. In the rear cross member 13, an upper end part is joined to a substantially intermediate portion of the upper wall panel 16 in the vehicle front-rear direction, and a rear edge part on the lower end side is joined to a front edge part of the lower wall panel 17. The lower wall panel 17 forms a box-shaped hollow portion between itself and a rear half region of the upper wall panel 16.

Specifically, left and right side edge parts of the lower wall panel 17 are bent upward and extend, and bent upper edge parts thereof are joined to left and right side edge parts of the upper wall panel 16. Also, a space between a front end part of the lower wall panel 17 and the upper wall panel 16 is closed by the rear cross member 13, and a space between the lower wall panel 17 and a rear end part of the upper wall panel 16 is closed by the rear panel 21. The box-shaped hollow portion configured in this manner extends to a rear side of the rear cross member 13 and left and right rear side frames 10. Also, a rear bumper 22 having a substantially hat-shaped cross section is joined to a central region of the rear end parts of the upper wall panel 16 and the lower wall panel 17 which are closed by the rear panel 21.

A plurality of (for example, six) reinforcing beads 23 extending in the vehicle body front-rear direction are formed in a central region of the lower wall panel 17 in the vehicle width direction to be spaced apart at substantially regular intervals in the vehicle width direction. The reinforcing beads 23 each having a chevron-shaped cross section that bulges to a downward side or an upward side of the vehicle extend in the vehicle body front-rear direction. Each of the reinforcing beads 23 extends from a position on the rear side of the rear cross member 13 (outer position in the vehicle body front-rear direction) toward a vehicle body front side (center side in the vehicle body front-rear direction) to be in contact with the rear cross member 13.

As illustrated in FIG. 2, the rear cross member 13 is joined to a lower surface of the upper wall panel 16, thereby forming a substantially rectangular closed cross section between itself and the upper wall panel 16. The rear cross member 13 includes, in a bottom view, a central extension portion 13c (central region) extending in the vehicle width direction, and a pair of inclined extension portions 13s bent at an obtuse angle and extending from outer end parts of the central extension portion 13c on both sides in the vehicle width direction toward the vehicle body front side (center side in the vehicle body front-rear direction). A bent portion 13b is provided between the central extension portion 13c and each of the inclined extension portions 13s. Further, the term “bent” in the bent portion 13b provided between the central extension portion 13c and each inclined extension portion 13s is not limited to an angularly bent form and also includes a curvedly bent form.

Also, as illustrated in FIG. 2, the rear cross member 13 of the present embodiment includes a front plate 13f having a substantially L-shaped cross section orthogonal to the vehicle width direction, and a rear plate 13r having a substantially I-shaped cross section orthogonal to the vehicle width direction.

The front plate 13f includes a vertical wall 24 extending in a vertical direction, and a lower wall 25 extending to a vehicle rear side from a lower end of the vertical wall 24. An upper flange 26 bent and extending to a vehicle front side is provided at an upper end part of the vertical wall 24. An upper surface of the upper flange 26 is joined to the lower surface of the upper wall panel 16 of the floor panel structure 15. An uneven portion such as the reinforcing bead extending in the vehicle body front-rear direction is not formed at a portion of the upper wall panel 16 to which the upper flange 26 of the front plate 13f is joined. The upper flange 26 is joined to a portion of the upper wall panel 16 that does not have an uneven portion extending in the vehicle body front-rear direction.

In the present embodiment, the upper flange 26 of the front plate 13f constitutes a joint portion 35 of the cross member with the floor panel structure 15 on a center side (front side) in the vehicle body front-rear direction. Hereinafter, this joint portion 35 will be referred to as a “front joint portion 35”.

The rear plate 13r has a vertical wall 27 that extends in the vertical direction on a rear side of the vertical wall 24 of the front plate 13f. An upper flange 28 bent and extending to the vehicle front side is provided at an upper end part of the vertical wall 27. A lower flange 29 bent and extending to the vehicle rear side is provided at a lower end part of the vertical wall 27. An upper surface of the upper flange 28 is joined to a lower surface of the upper wall panel 16 of the floor panel structure 15. The lower flange 29 faces an upper surface of a rear edge part of the lower wall 25 of the front plate 13f in the vertical direction. A front edge part of the lower wall panel 17 of the floor panel structure 15 is inserted between the lower flange 29 and the rear edge part of the lower wall 25. The lower flange 29 and the lower wall 25 are fixed to each other by welding or the like with the front edge part of the lower wall panel 17 sandwiched therebetween. The front edge part of the lower wall panel 17 is joined to the rear cross member 13 while being sandwiched between the lower flange 29 and the rear edge part of the lower wall 25.

In the present embodiment, the lower flange 29 and the rear edge part of the lower wall 25 constitute a joint portion 30 of the cross member with the floor panel structure 15 on an outer side (rear side) in the vehicle body front-rear direction. Hereinafter, this joint portion 30 will be referred to as a “rear joint portion 30”.

The plurality of reinforcing beads 23 formed on the lower wall panel 17 extend to positions that do not reach the front joint portion 35 on a front side of the rear cross member 13 in a bottom view of the vehicle. That is, the plurality of reinforcing beads 23 extend to a position that does not reach the joint portion of the cross member with the floor panel structure 15 on the center side in the vehicle body front-rear direction. In the case of the present embodiment, the plurality of reinforcing beads 23 are configured such that front end parts are in contact with a rear end part of the rear joint portion 30 on a rear side of the rear cross member 13 and extend to a position that does not reach the front joint portion 35 on the front side of the rear cross member 13.

Also, as illustrated in FIG. 1, three reinforcing beads 23 in a left half region of the lower wall panel 17 are disposed at positions intersecting an extension portion of the support bracket 19r on a left side (upper side in FIG. 1) of the rear cross member 13 in the vehicle width direction. The left support bracket 19r is fixed to a lower surface of the lower wall 25 of the rear cross member 13 to straddle the bent portion 13b between the central extension portion 13c and the left inclined extension portion 13s of the rear cross member 13. Of the reinforcing beads 23 in the left half region, a reinforcing bead 23L (23) positioned on a leftmost side is disposed at a position intersecting the left bent portion 13b.

Similarly, as illustrated in FIG. 1, the three reinforcing beads 23 in a right half region of the lower wall panel 17 are disposed at positions intersecting an extension portion of the support bracket 19r on a right side (lower side in FIG. 1) of the rear cross member 13 in the vehicle width direction. The right support bracket 19r is fixed to a lower surface of the lower wall 25 of the rear cross member 13 to straddle the bent portion 13b between the central extension portion 13c and the right inclined extension portion 13s of the rear cross member 13. Of the reinforcing beads 23 in the right half region, a reinforcing bead 23R (23) positioned on a rightmost side is disposed at a position intersecting the right bent portion 13b.

As described above, in the lower vehicle body structure of the present embodiment, the reinforcing beads 23 formed on the lower wall panel 17 of the floor panel structure 15 are in contact with the rear joint portion 30 of the rear cross member 13 and extend to a position that does not reach the front joint portion 35 of the rear cross member 13. Therefore, when an impact load is input from the rear of the vehicle, the input load is smoothly transmitted to the rear cross member 13 via the reinforcing beads 23, and deformation of the inclined extension portion 13s of the rear cross member 13 in an opening direction can be suppressed. That is, in the present configuration, since the reinforcing beads 23 do not reach the front joint portion 35 of the rear cross member 13, tension of the floor panel structure 15 (the upper wall panel 16) acts on the front joint portion 35 of the rear cross member 13 with the floor panel structure 15 to suppress the deformation of the inclined extension portion 13s of the rear cross member 13 in the opening direction. Therefore, the impact load input to the floor panel structure 15 from the rear of the vehicle can be efficiently received by the left and right rear side frames 10.

Therefore, if the lower vehicle body structure of the present embodiment is employed, energy absorption due to crushing of the floor panel structure 15 or the like can proceed smoothly when an impact load is input from the rear of the vehicle. Therefore, when the lower vehicle body structure of the present embodiment is employed, it is possible to contribute to development of a sustainable transportation system.

Also, in the lower vehicle body structure of the present embodiment, the reinforcing beads 23 are disposed at a position intersecting an installation portion (the support bracket 19r) of the drive unit 18, which is a part disposed below the vehicle body, in the vehicle width direction. Therefore, the impact load input to the reinforcing beads 23 from the rear of the vehicle is input to a portion of the central extension portion 13c of the rear cross member 13 to which the installation portion (the support bracket 19r) of the drive unit 18 is fixed. At this time, a portion of the central extension portion 13c of the rear cross member 13 to which the impact load is input through the reinforcing beads 23 is firmly reinforced by the installation portion (the support bracket 19r) of the drive unit 18. Therefore, a rigidity of the central extension portion 13c of the rear cross member 13 increases, making it difficult for the central extension portion 13c to deform, and it also becomes difficult for deformation behavior of the reinforcing beads 23 in an opening shape to be transmitted to the inclined extension portion 13s side of the rear cross member 13.

Therefore, if the present configuration is employed, energy absorption due to crushing of the floor panel structure 15 or the like can proceed more smoothly when an impact load is input from the rear of the vehicle.

Further, in the lower vehicle body structure of the present embodiment, the installation portion (the support bracket 19r) of the drive unit 18, which is a part disposed below the vehicle body, is fixed to straddle the bent portion 13b between the central extension portion 13c and the inclined extension portion 13s of the rear cross member 13. Thereby, the bent portion 13b between the central extension portion 13c and the inclined extension portion 13s of the rear cross member 13 is firmly reinforced by the installation portion (the support bracket 19r) of the drive unit 18. As a result, when an impact load is input from the rear of the vehicle body, deformation of the rear cross member 13 with the bent portion 13b as a starting point can be suppressed by the installation portion (the support bracket 19r) of the drive unit 18.

Therefore, when the present configuration is employed, an impact load input to the floor panel structure 15 from the rear of the vehicle can be more efficiently received by the left and right rear side frames 10.

### Second Embodiment

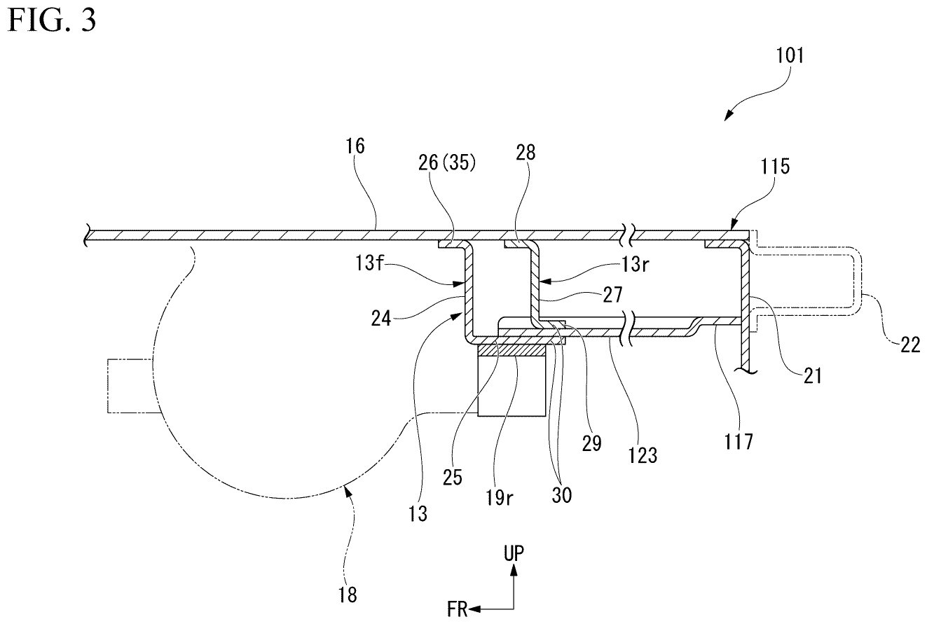

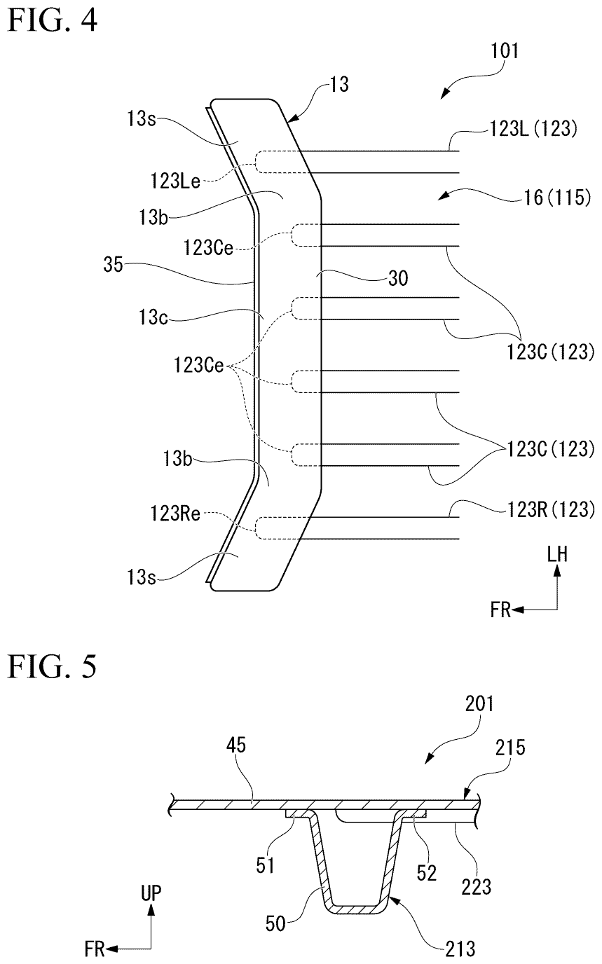

FIG. 3 is a cross sectional view of a vehicle 101 of the present embodiment similar to FIG. 2 of the first embodiment. FIG. 4 is a view of the vehicle 101 of the present embodiment from below.

In the vehicle 101 of the present embodiment, as in the first embodiment, front regions of left and right rear side frames (not illustrated) are connected to each other by a front cross member (not illustrated), and rear regions are connected to each other by a rear cross member 13. A floor panel structure 115 having a double panel structure is joined to the left and right rear side frames, the front cross member, and the rear cross member 13. The floor panel structure 115 includes an upper wall panel 16 and a lower wall panel 117 as in the first embodiment, and a plurality of (for example, six) reinforcing beads 123 extending in a vehicle body front-rear direction are formed on the lower wall panel 117 to be spaced apart at substantially regular intervals in a vehicle width direction. The reinforcing beads 123 each having a chevron-shaped cross section that bulges to a downward side or an upward side of the vehicle extend in the vehicle body front-rear direction. Each of the reinforcing beads 123 extends from a position on a rear side of the rear cross member 13 (an outer position in the vehicle body front-rear direction) toward a vehicle body front side (a center side in the vehicle body front-rear direction) to intersect the rear cross member 13.

Similarly to the first embodiment, the rear cross member 13 includes, in a bottom view, a central extension portion 13c (central region) extending in the vehicle width direction, and a pair of inclined extension portions 13s bent at an obtuse angle and extending from outer end parts of the central extension portion 13c on both sides in the vehicle width direction toward the vehicle body front side (center side in the vehicle body front-rear direction). A bent portion 13b is provided between the central extension portion 13c and each of the inclined extension portions 13s. The rear cross member 13 includes a front plate 13f and a rear plate 13r as in the first embodiment.

A front edge part of the lower wall panel 117 of the floor panel structure 115 is inserted between a lower flange 29 of the rear plate 13r and a lower wall 25 of the front plate 13f. The front edge part of the lower wall panel 117 extends to substantially a center position of the lower wall 25 of the front plate 13f in the vehicle body front-rear direction. The lower flange 29 and the lower wall 25 are fixed to each other by welding or the like with the front edge part of the lower wall panel 117 sandwiched therebetween. The front edge part of the lower wall panel 117 is joined to the rear cross member 13 while being sandwiched between the lower flange 29 and the rear edge part of the lower wall 25.

Also in the case of the present embodiment, the lower flange 29 and the rear edge part of the lower wall 25 constitute a joint portion of the cross member with the floor panel structure 115 on an outer side (rear side) in the vehicle body front-rear direction. Hereinafter, this joint portion will be referred to as a “rear joint portion 30”. Also, an upper flange 26 of the front plate 13f joined to a lower surface of the upper wall panel 16 constitutes a joint portion of the cross member with the floor panel structure 115 on a center side (front side) in the vehicle body front-rear direction. Hereinafter, this joint portion will be referred to as a “front joint portion 35”.

In the case of the present embodiment, the plurality of reinforcing beads 123 are configured such that front end parts intersect a rear end part of the rear joint portion 30 on a rear side of the rear cross member 13 and extend to positions that do not reach the front joint portion 35 on a front side of the rear cross member 13. Therefore, the plurality of reinforcing beads 123 extend to the center side (front side) in the vehicle body front-rear direction beyond the joint portion (the rear joint portion 30) of the cross member (the rear cross member 13) with the floor panel structure 115 on an outer side in the vehicle body front-rear direction.

Also, of the plurality of reinforcing beads 123, a reinforcing bead 123L positioned on a leftmost side is disposed to intersect the left inclined extension portion 13s of the rear cross member 13, and a reinforcing bead 123R positioned on a rightmost side is disposed to intersect the right inclined extension portion 13s of the rear cross member 13. Remaining four reinforcing beads 123C on the center side are disposed to intersect the central extension portion 13c of the rear cross member 13.

As illustrated in FIG. 4, front end parts 123Le and 123Re of the left and right reinforcing beads 123L and 123R are disposed on the vehicle body front side with respect to front end parts 123Ce of the reinforcing beads 123C in the central region. That is, the left and right reinforcing beads 123L and 123R intersecting the inclined extension portions 13s extend longer to a vehicle front side than the four reinforcing beads 123C of the central region that intersect the central extension portion 13c of the rear cross member 13.

Since a basic configuration of the lower vehicle body structure of the present embodiment is the same as that of the first embodiment, it is possible to obtain the same basic effects as in the first embodiment described above.

Also, in the lower vehicle body structure of the present embodiment, the plurality of reinforcing beads 123 extend to the vehicle body front side (the center side in the vehicle body front-rear direction) beyond the rear joint portion 30 (the joint portion with the floor panel structure 115 on an outer side in the vehicle body front-rear direction) of the rear cross member 13. Therefore, an impact load input to the floor panel structure 115 from the rear of the vehicle body can be efficiently transmitted to the rear cross member 13 through the plurality of reinforcing beads 123.

Therefore, when the present configuration is employed, an impact load input from the rear of the vehicle via the plurality of reinforcing beads 123 can be more efficiently received by the left and right rear side frames, and energy absorption due to crushing of the floor panel structure 115 or the like can proceed more smoothly.

Further, in the lower vehicle body structure of the present embodiment, of the plurality of reinforcing beads 123, the reinforcing beads 123L and 123R intersecting the inclined extension portions 13s of the rear cross member 13 extend further to the vehicle body front side (the center side in the vehicle body front-rear direction) than the reinforcing beads 123C intersecting the central extension portion 13c. Therefore, when the reinforcing beads 123L and 123R intersecting the inclined extension portions 13s of the rear cross member 13 are made to extent to the maximum extent to the vehicle body front side (the center side in the vehicle body front-rear direction), an impact load input to the floor panel structure 115 can be efficiently transmitted to the rear cross member 13 via the plurality of reinforcing beads 123 while suppressing deformation of the inclined extension portions 13s.

### Third Embodiment

FIG. 5 is a cross-sectional view of a vehicle 201 of the present embodiment similar to FIG. 2 of the first embodiment.

In each of the embodiments described above, the floor panel structure has a double panel structure having the upper wall panel and the lower wall panel, but a lower vehicle body structure of the vehicle 201 of the present embodiment is constituted by a floor panel structure 215 with a single panel structure. That is, the floor panel structure 215 is constituted by a single rear floor panel 45 joined to a rear cross member 213 and a pair of rear side frames (not illustrated).

The rear cross member 213 is configured such that, for example, a front flange 51 and a rear flange 52 are provided at a front upper end part and a rear upper end part of a cross member main body 50 having a substantially U-shaped cross section that opens upward. The front flange 51 and the rear flange 52 are joined to a lower surface of the rear floor panel 45 at a distance from each other in a vehicle body front-rear direction.

In the present embodiment, the front flange 51 of the rear cross member 213 constitutes a joint portion of the cross member with the floor panel structure 215 on a center side in the vehicle body front-rear direction, and the rear flange 52 of the rear cross member 213 constitutes a joint portion of the cross member with the floor panel structure 215 on an outer side in the vehicle body front-rear direction.

Although detailed illustrations are omitted, also in the case of the present embodiment, the rear cross member 213 includes, in a bottom view, a central extension portion (central region) extending in the vehicle width direction, and a pair of inclined extension portions bent at an obtuse angle and extending from outer end parts of the central extension portion on both sides in the vehicle width direction toward the vehicle body front side (center side in the vehicle body front-rear direction).

Also, a plurality of reinforcing beads 223 extending from a position rearward of the rear cross member 213 (outer position in the vehicle body front-rear direction) toward the vehicle body front side (center side in the vehicle body front-rear direction) to be in contact with the rear cross member 213 are formed on the rear floor panel 45 (the floor panel structure 215). The plurality of reinforcing beads 223 are formed on the rear floor panel 45 to be spaced apart from each other in the vehicle width direction. In the case of the present embodiment, the plurality of reinforcing beads 223 intersect the rear flange 52 of the rear cross member 213 and extend to positions that do not reach the front flange 51. The front flange 51, which is a joint portion of the rear cross member 213 on the front side, is joined to a portion of the rear floor panel 45 that does not have an uneven shape such as a reinforcing bead.

In the lower vehicle body structure of the present embodiment, the floor panel structure 215 is constituted by the single rear floor panel 45, but the plurality of reinforcing beads 223 intersect the rear flange 52 and extend to positions that do not reach the front flange 51. Thereby, tension of the floor panel structure 215 (the rear floor panel 45) acts on the front joint portion (the front flange 51) of the rear cross member 213 with the floor panel structure 215 to suppress deformation of the inclined extension portions of the rear cross member 213 in an opening direction. Therefore, an impact load input to the floor panel structure 215 from the rear of the vehicle can be efficiently received by the left and right rear side frames.

Therefore, also in the case of the present embodiment, when an impact load is input from the rear of the vehicle, energy absorption due to crushing of the floor panel structure 215 or the like can proceed smoothly.

The present invention is not limited to the above-described embodiments, and various modifications can be made in design in a range not departing from the gist of the present invention. For example, in the above-described embodiment, the central extension portion extending in the vehicle width direction has been provided in the central region of the rear cross member, but a shape of the central region of the rear cross member is not limited to a shape extending in the vehicle width direction, and may be other shapes such as a rectangular block shape. Also, in the first and second embodiments, each six reinforcing beads 23 and 123 have been provided on the lower wall panels 17 and 117, but the number of the reinforcing beads 23 and 123 provided on the lower wall panels 17 and 117 is not limited to six, and an appropriate number can be selected depending on vehicles.

Also, although the above-described embodiments have described the lower vehicle body structure on a rear side of the vehicle, a similar configuration can be employed for a lower structure on a front side of the vehicle. Specifically, in a structure in which a front cross member is connected to left and right front side frames extending substantially in a vehicle body front-rear direction, and a floor panel is joined to the front side frames and the front cross member, reinforcing beads similar to those described above may be formed on the floor panel.

Also, in the above-described embodiment, the drive unit 18 has been mentioned as an example of the part disposed below the vehicle body and fixed to the cross member (the rear cross member 13), but a part disposed below the vehicle body and fixed to the cross member is not limited thereto. A part disposed below the vehicle body and fixed to the cross member may be, for example, a suspension part, a wiring holding part, or the like.

### BRIEF DESCRIPTION OF THE REFERENCE SYMBOLS

10: Rear side frame (side frame)
13, 213: Rear cross member (cross member)
13b: Bent portion
13c: Central extension portion (central region)
13s: Inclined extension portion
15, 115, 215: Floor panel structure
18: Drive unit (part disposed below vehicle body)
19r: Support bracket (installation portion)
23, 123, 223: Reinforcing bead
30: Rear joint portion (joint portion)
35: Front joint portion (joint portion)
51: Front flange (joint portion)
52: Rear flange (joint portion)

What is claimed is:

1. A lower vehicle body structure comprising:
a pair of side frames extending substantially in a vehicle body front-rear direction at a rear side or a front side of a center in the vehicle body front-rear direction;
a cross member connected to the pair of side frames; and
a floor panel structure joined to the pair of side frames and the cross member, wherein
the cross member includes a pair of inclined extension portions bent at an obtuse angle and extending from both end parts of a central region in a vehicle width direction toward a center side in the vehicle body front-rear direction,
the floor panel structure includes a reinforcing bead extending from a position on an outer side of the cross member in the vehicle body front-rear direction toward the center side in the vehicle body front-rear direction to be in contact with the cross member, and
the reinforcing bead extends to a position that does not reach a joint portion of the cross member with the floor panel structure on the center side in the vehicle body front-rear direction.

2. The lower vehicle body structure according to claim 1, wherein
an installation portion of a part disposed below a vehicle body is fixed to the central region of the cross member, and
the reinforcing bead is disposed at a position intersecting the installation portion in the vehicle width direction.

3. The lower vehicle body structure according to claim 1, wherein
an installation portion of a part disposed below a vehicle body is fixed to the central region of the cross member, and
the installation portion is fixed to straddle a bent portion between the central region and each of the inclined extension portions of the cross member.

4. The lower vehicle body structure according to claim 1, wherein the reinforcing bead extends to the center side in the vehicle body front-rear direction beyond the joint portion of the cross member with the floor panel structure on an outer side in the vehicle body front-rear direction.

5. The lower vehicle body structure according to claim 4, wherein
a plurality of the reinforcing beads are provided on the floor panel structure to be spaced apart from each other in the vehicle width direction, and
the reinforcing bead intersecting the inclined extension portion of the cross member extends further to the center side in the vehicle body front-rear direction than the reinforcing bead intersecting the central region of the cross member.
